(19) United States
(12) Patent Application Publication
(10) Pub. No.: US 2011/0001810 A1
(43) Pub. Date: Jan. 6, 2011

(54) IMAGE PICKUP APPARATUS AND ELECTRONIC ENDOSCOPE

(75) Inventors: Mikio NAKAMURA, Tokyo (JP); Naoki YOSHIDA, Kamiina-gun (JP); Tsutomu NAKAMURA, Kamiina-gun (JP); Fukashi YOSHIZAWA, Ina-shi (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/828,664

(22) Filed: Jul. 1, 2010

(30) Foreign Application Priority Data
Jul. 3, 2009 (JP) JP2009-158641

(51) Int. Cl. H04N 7/18; H04N 5/228

(52) U.S. Cl. 348/65; 348/222.1; 348/E07.085; 348/E05.024

(57) ABSTRACT

An image pickup apparatus includes an image pickup module which is provided with a plurality of functional elements for obtaining image information of an object to be photographed, and a signal separation circuit which separates a drive signal from a combined signal in which, at least two of a plurality of drive signals for the plurality of functional elements respectively, are superimposed, an image pickup module control section which is provided with a signal combining section which superimposes at least two of the plurality of drive signals, and a signal transmitting section which is interposed between the image pickup module and the image pickup module control section, and which transmits the combined signal in which, at least two of the plurality of drive signals are superimposed.

### CROSS-REFERENCE TO RELATED APPLICATIONS

The present application is based upon and claims the benefit of priority from the prior Japanese Patent Application No. 2009-158641 filed on Jul. 3, 2009; the entire contents of which are incorporated herein by reference.

### BACKGROUND OF THE INVENTION

1. Field of the Invention

The present invention relates to an image pickup apparatus, particularly, a small-size image pickup apparatus, and an electronic endoscope which includes such image pickup apparatus.

2. Description of the Related Art

In an image pickup apparatus, such as a small-size image pickup apparatus which is to be accommodated in a front end of an endoscope, more functionality such as a zooming function, an auto focus function (AF), and mounting of a front-end lighting member has hitherto been sought. However, a diameter of the endoscope being restricted, it has been difficult to secure space for a signal line and a power supply line for having more functionality.

As a small-size image pickup apparatus, structures proposed in Japanese Patent Application Laid-open Publication Nos. 2004-159833 and 2008-172693 have been known. In an electronic endoscope apparatus described in Japanese Patent Application Laid-open Publication No. 2004-159833, by making an arrangement such that an electric power is supplied by electromagnetic induction, and an image signal and a control signal are transmitted and received by radio waves, the number of contacts is reduced to minimum.

Moreover, an image pickup unit described in Japanese Patent Application Laid-open Publication No. 2008-172693 is provided as a small-size image pickup unit which does not require a separate distribution cable by letting a structure include an electrode which is formed on at least two of a one end portion of a lens barrel, the other end portion of the lens barrel, and a trunk portion of the lens barrel, a wire portion which connects the electrodes electrically, and a functional element (a drive element and a light emitting element) and an image pickup element provided near one end portion or both end portions, and the trunk portion of the lens barrel

### SUMMARY OF THE INVENTION

An image pickup apparatus according to the present invention includes an image pickup module which is provided with a plurality of functional elements for obtaining image information of an object to be photographed, and a signal separation circuit which separates a drive signal from a combined signal in which, at least two of a plurality of drive signals for the plurality of functional elements respectively, are superimposed, an image pickup module control section which is provided with a signal combining section which superimposes at least two of the plurality of drive signals, and a signal transmitting section which is interposed between the image pickup module and the image pickup module control section, and which transmits the combined signal in which, at least two of the plurality of drive signals are superimposed.

### BRIEF DESCRIPTION OF THE DRAWINGS

FIG. 1 is a block diagram showing a structure of an image pickup apparatus according to a first embodiment;

FIG. 2 is a cross-sectional view showing an example of a schematic structure of an image pickup module in the image pickup apparatus according to the first embodiment;

FIG. 3 is a block diagram showing a structure of an image pickup apparatus according to a second embodiment; and

FIG. 4 is a diagram showing a schematic structure of an electronic endoscope system which includes the image pickup apparatus according to the first embodiment and the second embodiment.

### DETAILED DESCRIPTION OF THE PREFERRED EMBODIMENTS

Exemplary embodiments of an image pickup apparatus and an electronic endoscope according to the present invention will be described below in detail by referring to the accompanying diagrams. However, the present invention is not restricted to the embodiments described below.

### First Embodiment

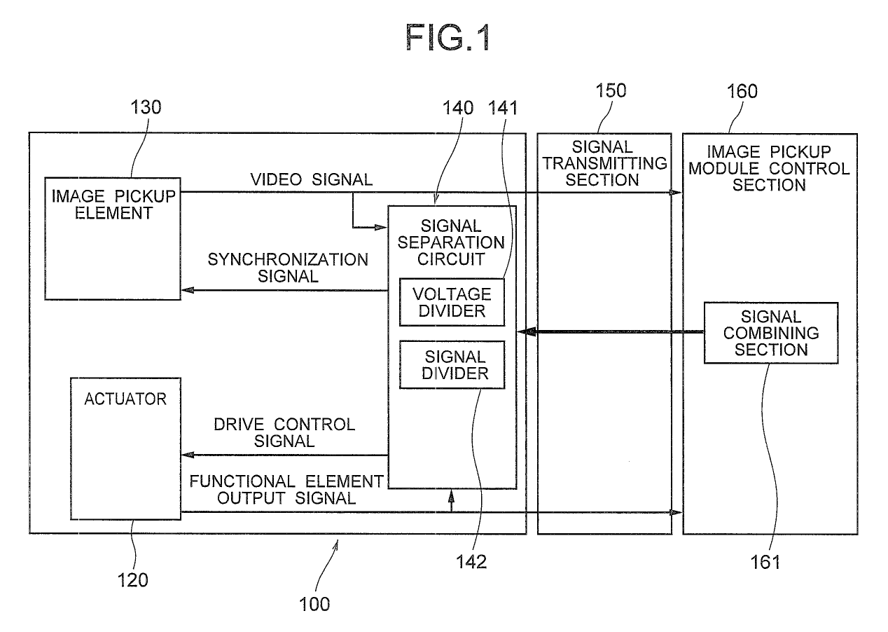

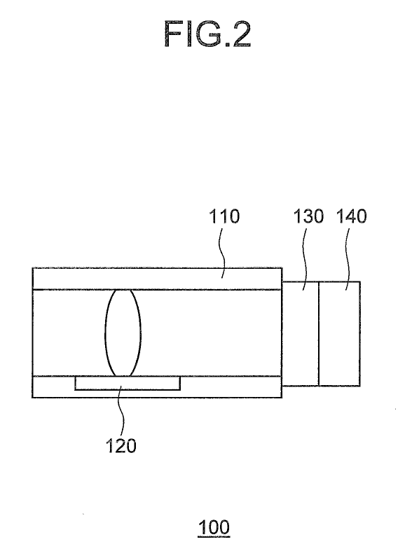

An image pickup apparatus and an electronic endoscope according to a first embodiment of the present invention will be described below while referring to FIG. 1 and FIG. 2. FIG. 1 is a block diagram showing a structure of the image pickup apparatus according to the first embodiment. FIG. 2 is a cross-sectional view showing an example of a schematic structure of an image pickup module 100 in the image pickup apparatus according to the first embodiment.

The image pickup apparatus according to the first embodiment, as shown in FIG. 1, includes the image pickup module 100, a signal transmitting section 150, and an image pickup module control section 160. The image pickup module 100 includes an image pickup element 130 (such as a CCD (charge coupled device) and a CMOS (Complementary Metal Oxide Semiconductor)) and an actuator 120 for driving an optical system, as a functional element, and a signal separation circuit 140.

As a functional element, a position detecting element and a light emitting element can be used apart from the image pickup element 130 and the actuator 120 for driving the optical system. In the following description, a case in which the actuator 120 is a functional element and a case in which the image pickup element 130 is a functional element are described. However, the image pickup apparatus and the electronic endoscope of the present invention are also applicable to a case in which there are three or more functional elements.

In the image pickup module 100, as shown in FIG. 2 for example, the actuator 120 is provided inside an optical system 110, and the image pickup element 130 is disposed at one end of the optical system 110, and the signal separation circuit 140 is connected to the image pickup element 130.

A combined signal in which, a drive signal for the actuator 120 and a drive signal for the image pickup element 130 are superimposed is input to the signal separation circuit 140 from the image pickup module control section 160. The signal transmitting section 150 is interposed between the signal separation circuit 140 and the image pickup module control section 160, and the combined signal in which the drive signals are superimposed is input to the signal separation circuit 140 via the signal transmitting section 150.

A signal combining section 161 in the image pickup module control section 160 superimposes the drive signals. When there are three or more functional elements, the signal combining section 161 superimposes at least two drive signals (superimposes drive signals of least two functional elements).

The signal separation circuit 140 includes a voltage divider 141 and a signal divider 142, and separates the drive signals from the combined signal in which the drive signals are superimposed. The voltage divider 141 generates and distributes a voltage necessary for the actuator 120 and the image pickup element 130. Moreover, a drive control signal which controls an operation of each of the actuator 120 and the image pickup element 130 is distributed to each of the actuator 120 and the image pickup element 130 by the signal divider 142.

A synchronization signal for a video signal output is supplied to the image pickup element 130 by the signal divider 142, and the image pickup element 130 is operated based on the synchronization signal which is supplied. A drive control signal is supplied to the actuator 120 by the signal divider 142, and the actuator 120 is operated based on the drive control signal.

The video signal obtained by the image pickup element 130 is sent to the image pickup module control section 160 via the signal transmitting section 150, as well as is input to the signal separation circuit 140. Moreover, an output signal (functional element output signal) from the actuator 120 is input to the signal separation circuit 140 and the image pickup module control section 160. The signal combining section 161, is capable of generating a combined signal by superimposing also the output signals from the actuator 120 and the video signal from the image pickup element 130, apart from the signals which control the drive of each functional element, and this combined signals can also be separated to a signal for each functional element, in the signal separation circuit 140.

Here, in the electronic endoscope according to the first embodiment, the image pickup module 100 in a structure shown as an example in FIG. 2 is disposed inside a hard tip portion facing an object to be photographed. In this image pickup module 100, the actuator 120 drives the optical system 110 and the image pickup element 130 obtains image information of the object to be photographed. In this case, the image pickup module control section 160 is disposed at operator's side, and the signal transmitting section 150 is disposed in an inserting portion.

In the image pickup apparatus and the electronic endoscope according to the first embodiment structured as described above, by transmitting and receiving the drive signals and electric power signals to the plurality of functional elements and a signal which is multiplexed by overlapping information signals from the functional elements between the image pickup module control section 160 and the image pickup module 100, it is possible to secure signal lines and power supply lines necessary in a limited space, thereby making it possible to realize a small and high performance image pickup apparatus.

### Second Embodiment

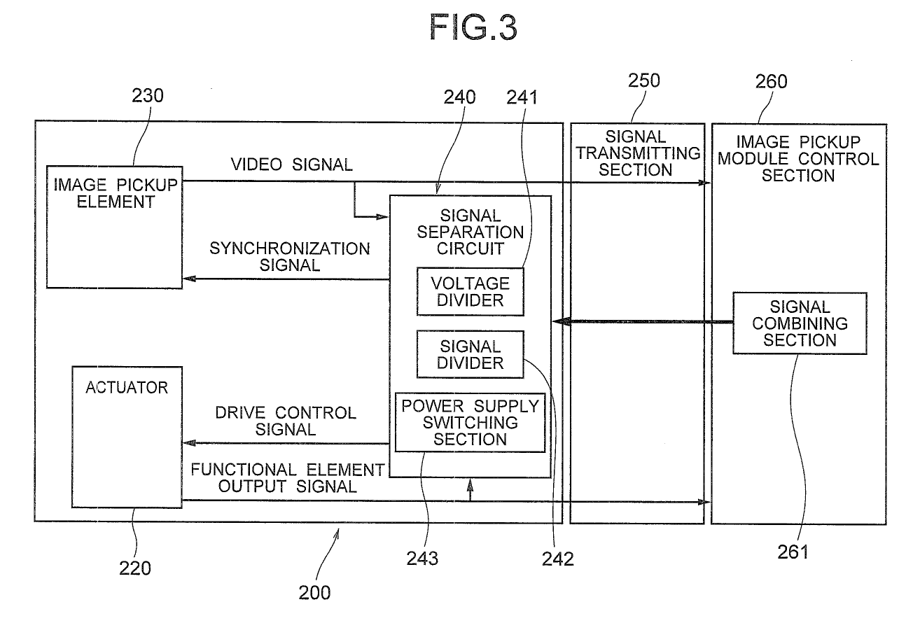

Next, an image pickup apparatus and an electronic endoscope according to a second embodiment of the present invention will be described below by referring to FIG. 3. FIG. 3 is a block diagram showing a structure of the image pickup apparatus according to the second embodiment.

In the image pickup apparatus according to the second embodiment, a point that the image pickup apparatus includes a signal separation circuit 240 and a power supply switching section 243 differs from the image pickup apparatus according to the first embodiment. The rest of the structure is similar to the image pickup apparatus according to the first embodiment. Concretely, an image pickup module 200, an actuator 220, an image pickup element 230, a signal transmitting section 250, and an image pickup module control section 260 of the second embodiment correspond to the image pickup module 100, the actuator 120, the image pickup element 130, the signal transmitting section 150, and the image pickup module control section 160 of the first embodiment.

The signal separation circuit 240 includes a voltage divider 241 which corresponds to the voltage divider 141 and a signal divider 242 which corresponds to the signal divider 142 of the first embodiment, and also includes the power supply switching section 243.

The power supply switching section 243 switches upon selecting as to when the voltage is to be supplied to which of the image pickup element 230 and the actuator 220 as a functional element. By including such power supply switching section 243, the functional element to be operated can be selected easily. Furthermore, since the power is not supplied to the functional element which is not required to be operated, it is possible to reduce a stand-by power, and accordingly it is possible to save energy.

The reset of the structure, action, and effect are similar as in the first embodiment.

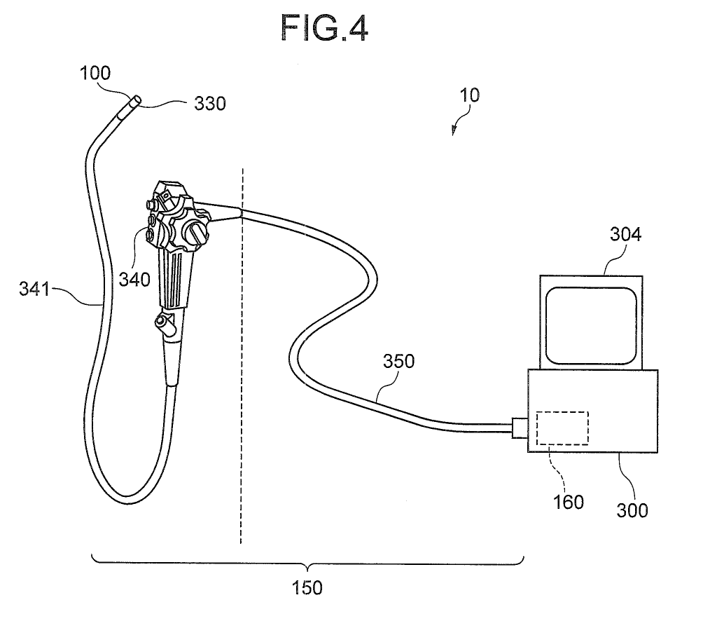

FIG. 4 shows a schematic structure of an electronic endoscope system 10 which includes the image pickup apparatus according to the first embodiment and the second embodiment described above. The electronic endoscope system 10 is provided with a hard tip portion 330 at a front end of an inserting portion 341 which is extended from an operating section 340. Moreover, the operating section 340 and a control section 300 are connected by a universal chord 350. A monitor 304 displays an image inside a body to be examined.

Here, the image pickup module 100 is provided inside the hard tip portion 330. Moreover, the image pickup module control section 160 is provided inside the control section 300. Furthermore, a portion from the universal chord 350 up to the inserting portion 341 corresponds to the signal transmitting section 150.

The electronic endoscope system 10 includes the image pickup apparatus described above. Therefore, the electronic endoscope system 10 shows an effect that it is possible to realize a high performance without increasing an outer shape, particularly the diameter.

As it has been described above, the image pickup apparatus according to the present invention is suitable for a small-size image pickup apparatus.

The image pickup apparatus and the electronic endoscope according to the present invention show an effect that it is possible to realize high performance without increasing an outer shape, particularly, the diameter.

What is claimed is:

1. An image pickup apparatus comprising:
an image pickup module which is provided with a plurality of functional elements for obtaining image information of an object to be photographed, and a signal separation circuit which separates a drive signal from a combined signal in which, at least two of a plurality of drive signals for the plurality of functional elements respectively, are superimposed;
an image pickup module control section which is provided with a signal combining section which superimposes at least two of the plurality of drive signals; and
a signal transmitting section which is interposed between the image pickup module and the image pickup module control section, and which transmits the combined signal in which, at least two of the plurality of drive signals are superimposed.

2. The image pickup apparatus according to claim 1, wherein the signal separation circuit includes at least one of a voltage divider which distributes a voltage to each of the plurality of functional elements, and a signal divider which distributes a signal controlling an operation to each of the plurality of functional elements.

3. The image pickup apparatus according to claim 2, wherein the voltage divider generates and distributes a voltage necessary for each of the plurality of functional elements.

4. The image pickup apparatus according to claim 2, wherein the signal separation circuit includes a power supply switching section which switches upon selecting the plurality of functional elements which supply an electric power.

5. An electronic endoscope comprising:
an image pickup apparatus according to claim 1.
